(19) United States
(12) Patent Application Publication
(10) Pub. No.: US 2019/0136793 A1
(43) Pub. Date: May 9, 2019

(54) PISTON WITH AN OPEN COOLING CHAMBER HAVING A FLOW-EFFECTIVE OIL GUIDING SURFACE AND METHOD FOR COOLING SAID PISTON

(71) Applicant: KS Kolbenschmidt GmbH, Karl-schmidt-strasse (DE)

(72) Inventors: Robert Kühnel, Heilbronn (DE); Klaus Lormes, Bad Wimpfen (DE); Andreas Rehl, Kirchheim (DE); Matthias Supper, Ubstadt-Weiher (DE)

(21) Appl. No.: 16/241,065

(22) Filed: Jan. 7, 2019

Related U.S. Application Data
(63) Continuation of application No. 15/119,767, filed on Aug. 18, 2016, now abandoned.

(30) Foreign Application Priority Data
Feb. 21, 2014 (DE) 102014203184.2

(51) Int. Cl. F02F 3/22; F01P 3/10

(52) U.S. Cl. CPC F02F 3/22; F01P 3/10

(57) ABSTRACT

An internal combustion engine piston having a cooling chamber open to in a direction toward of pin boss bores. The cooling chamber having at least one oil guiding surface having a slope. On directing a cooling oil spray stream onto the at least one sloped oil guiding surface, there is increased heat transfer from the piston to the cooling oil. In one example, the oil guiding surface slope has a concave or convex curvature.

### CROSS-REFERENCE TO RELATED APPLICATIONS

This continuation application claims priority benefit to U.S. utility patent application Ser. No. 15/119,767 filed Aug. 18, 2016 the entire contents of which is incorporated herein by reference.

### TECHNICAL FIELD

The invention relates to a piston having an open cooling chamber which has oil guiding surfaces which are favorable for flow, and to a method for cooling said piston in accordance with the features of the respective preambles of the independent patent claims.

### BACKGROUND

Methods for producing pistons are known. Pistons are produced, for example, in a forging process, in a casting process or other comparable processes.

DE 101 06 435 A1 relates to a piston for an internal combustion engine. Said piston comprises a piston head, a piston skirt which has a pair of piston boss bores and is of recessed configuration in the region of the piston boss bores, with the result that the piston head projects beyond the recessed piston skirt in the radial direction in the region of the piston boss bores, an oil guiding wall which encloses an oil jet impact zone being provided in a piston interior space which is delimited by the piston skirt and the piston head, and at least one through channel being provided which extends from the piston interior space to the piston outer region which is projected radially over by the piston head, in a manner which is directed in such a way that the oil which is fed in by way of the through channel is deflected by the piston head in the region of the piston head projecting length. As a result, it becomes possible to cool that circumferential edge region of the piston which is close to the piston ring by way of a predominantly open oil flow. The oil guiding surface is formed by way of the inner wall of the piston skirt in conjunction with the underside of the piston head and preferably comprises a groove zone which extends from the jet impact zone into the through channel.

### SUMMARY

It is an object of the invention to distribute the oil spray stream in an optimum manner onto the surface to be cooled and therefore to improve the heat transfer to the cooling medium, and to provide a method for cooling the piston.

This object is achieved by way of a piston and a method having the features of the independent patent claims.

It is provided according to the invention that at least one oil guiding surface of the cooling chamber has a slope in relation to the piston stroke axis.

The oil transport onto that side of the cooling chamber which is not sprayed onto directly is brought about by way of the slope of the at least one oil guiding surface. More effective utilization of the cooling oil takes place as a result. This results in a temperature reduction at the piston. The oil spray stream is distributed in an optimum manner to the surface to be cooled of the cooling chamber of the piston. The cooling chamber is of open configuration in the direction of the pin boss bores, with the result that the cooling oil can flow away freely. The cooling chamber is preferably configured so as to run around a central point, for example the piston stroke axis. The cooling chamber is preferably configured so as to be adjacent with respect to the ring zone and is delimited from the latter by way of a wall. The slope (inclination) of the oil guiding surface is, for example, between 0.5° and 45°, in relation to the piston stroke axis.

Furthermore, it is provided according to the invention that the slope of the at least one oil guiding surface is configured between a first point (or region) and at least one further point (or region). The cooling oil flows along the oil guiding surface, starting from the point (or spray region which is struck by the cooling oil) at which the oil spray stream strikes the oil guiding surface. The slope aids the flow of the cooling oil along the oil guiding surface, and the heat exchange between the oil guiding surface and the cooling oil is improved in an advantageous way.

Furthermore, it is provided according to the invention that the first point (or surface region) describes the height of the cooling chamber at its highest point.

Furthermore, it is provided according to the invention that the at least one further point (or surface region) describes the height of the cooling chamber at its lowest point.

The slope runs from a first point, the highest point of the cooling chamber, to the at least one further point, the lowest point of the cooling chamber. The cooling chamber therefore forms a defined plane or surface which is oriented obliquely in relation to the piston stroke axis (or else also in relation to the piston crown).

The slope therefore forms a circumferential oblique plane within the cooling chamber. The cooling oil is therefore guided along said oblique plane starting from the impact location. As a result, a high heat exchange capability is made possible.

Furthermore, it is provided according to the invention that the cooling chamber is delimited by way of three oil guiding surfaces. A cooling chamber which is open toward the bottom, in the direction of the pin boss bores (or a skirt lower edge), is formed by way of the delimitation by way of three oil guiding surfaces. As a result, the production costs for the piston decrease, since the configuration of a closed cooling channel is not required. Furthermore, the cooling oil can flow away freely after absorbing a quantity of heat.

Furthermore, it is provided according to the invention that the three oil guiding surfaces form a cooling chamber ceiling and lateral walls, one wall delimiting the cooling chamber in the direction of the ring zone, and one wall delimiting the cooling chamber in the direction of a combustion chamber recess. By way of said design, if a combustion chamber recess is present, a direct transfer of heat from the combustion chamber recess to the oil guiding surface which belongs to it is made possible, and therefore a transfer of heat to the cooling oil. The quantity of heat to be dissipated from the combustion process can therefore be dissipated by way of the cooling oil close to where it is produced.

Furthermore, it is provided according to the invention that the cooling chamber is of open design in the direction of the pin boss bores. This makes it possible for the cooling oil to flow away directly after absorbing a quantity of heat into the region below the piston. The transfer rate for the cooling oil is therefore increased.

Furthermore, it is provided according to the invention that the cooling chamber has a direct connection to an inner shape of the piston. The interface of the inner shape in the direction of the combustion chamber recess likewise serves for the exchange of heat. By virtue of the fact that the inner shape and the circumferential cooling chamber are in direct contact, the cooling oil can pass in an unimpeded manner from one into the other region.

Furthermore, it is provided according to the invention that the at least one oil guiding surface which has a slope has a convex curvature. As an alternative or in addition, it is provided according to the invention that the at least one oil guiding surface which has a slope has a concave curvature. An oil guiding surface which has a curvature aids flowing away of the cooling oil from the impact location. The heat exchange rate is increased further and the cooling performance of the piston is increased. The convex or concave configuration is dependent on the respective application.

Furthermore, it is provided according to the invention that the at least one oil guiding surface which has a slope is configured as a cooling chamber ceiling. As a result, the cooling oil which impacts is guided along the upper oil guiding surface. This ensures that the cooling oil flows circumferentially over the entire region which is adjacent with respect to the edge of the combustion chamber recess. This ensures a greater exchange of heat in a severely loaded region, the edge of the combustion chamber recess.

With regard to the method for cooling a piston having an open cooling chamber, the following steps are provided according to the invention:
directing of an oil spray stream onto at least one inclined oil guiding surface,
wetting of the at least one oil guiding surface with cooling oil,
guiding of the cooling oil along the oil guiding surfaces,
heat exchange between the oil guiding surfaces and the cooling oil,
discharge of the heated cooling oil through the cooling chamber which is open in the direction of the pin boss bores.

The above-described cooling method makes it possible to wet the entire or at least virtually the entire oil guiding surfaces in the cooling chamber. The heat exchange rate between the oil guiding surfaces and the cooling medium in the form of cooling oil is increased. The degree of efficiency of the cooling performance of the piston is increased.

In other words, an improvement of the cooling action is brought about by way of a directed oil stream. Up to now, the cooling chamber has been produced by way of flap technology with high material usage and machining work. The oil spray stream is distributed in an optimum manner onto the surface to be cooled as a result of the design according to the invention in the form of inclined oil guiding surfaces.

The oil transport onto that side of the cooling pocket which is not sprayed onto directly takes place by way of an inclined ceiling; as a result, more effective utilization of the cooling oil is achieved, which results in a temperature reduction at the piston. The cooling pocket ceiling is inclined by from 0.5° to 45°.

A piston according to the invention can be manufactured from steel, aluminum, alloys thereof, alloys or the like.

The piston according to the invention can also be of multiple piece configuration. It is essential that the at least one oil guiding surface is of inclined configuration.

### BRIEF DESCRIPTION OF THE DRAWINGS

One exemplary embodiment of the invention is shown in the figures and described in the following text.

FIGS. 1A and 1B show views of a piston according to the invention having an inclined cooling chamber ceiling,

FIGS. 2A and 2B show views of a further exemplary embodiment of a piston according to the invention having an inclined cooling chamber ceiling,

FIG. 3 shows a view of a further exemplary embodiment of a piston according to the invention having a concavely inclined cooling chamber ceiling, and

FIG. 4 shows a view of a further exemplary embodiment of a piston according to the invention having a convexly inclined cooling chamber ceiling.

### DETAILED DESCRIPTION

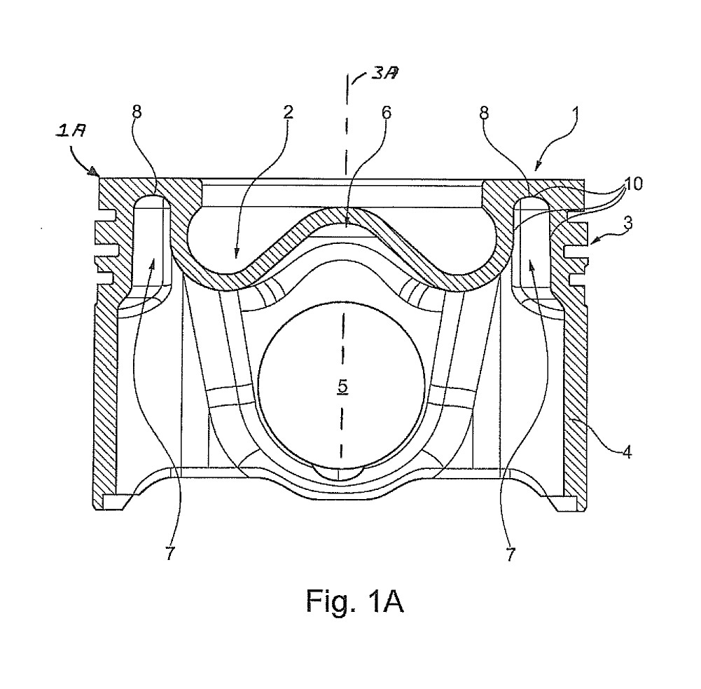

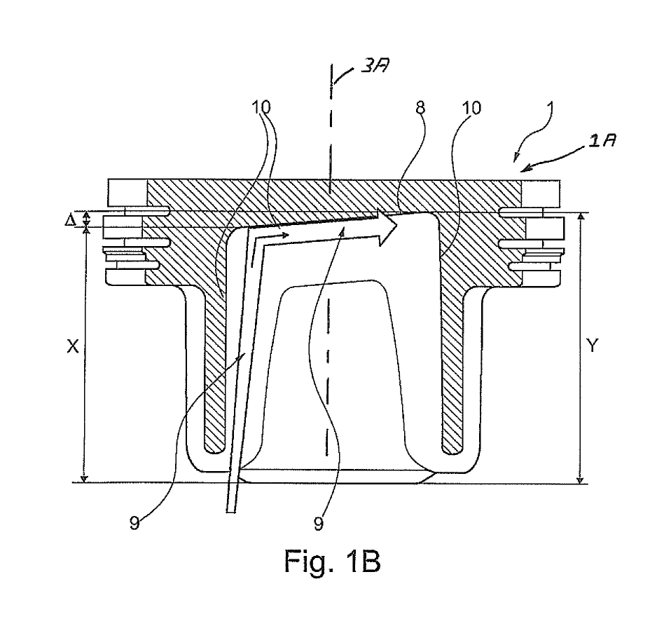

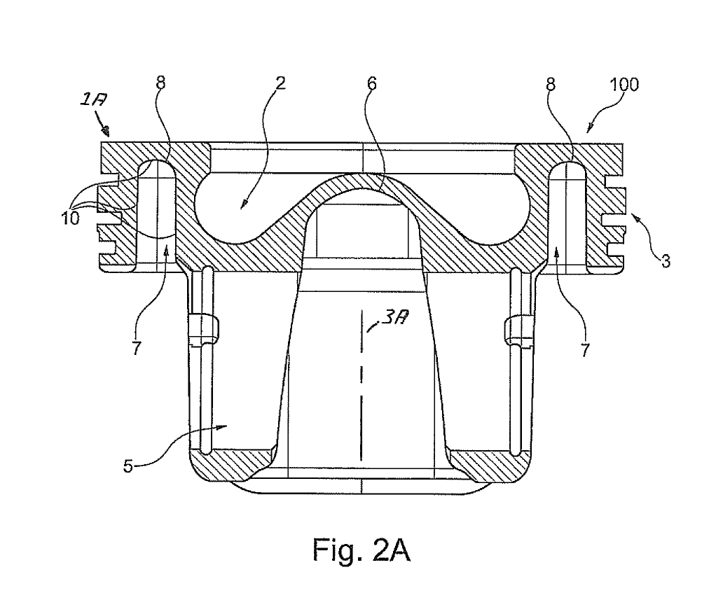

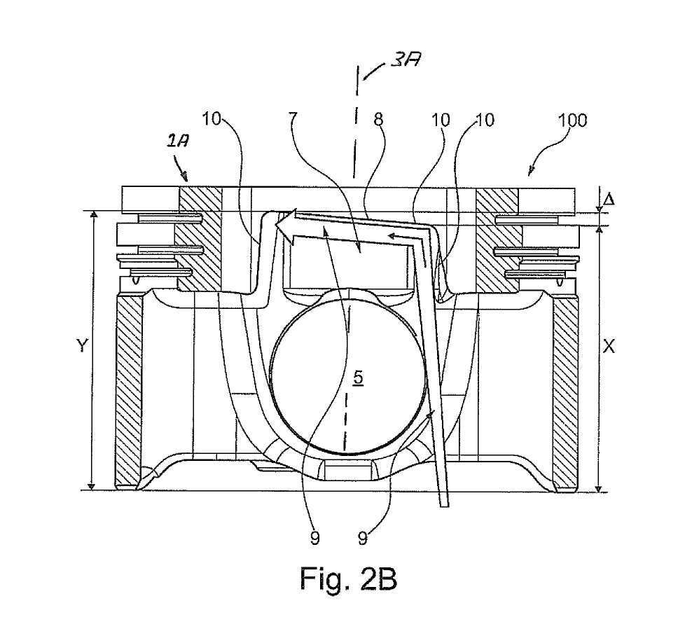

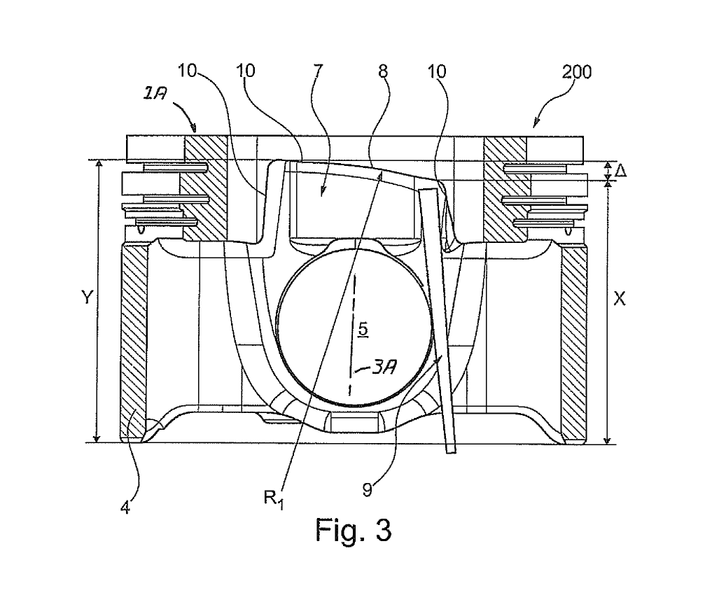

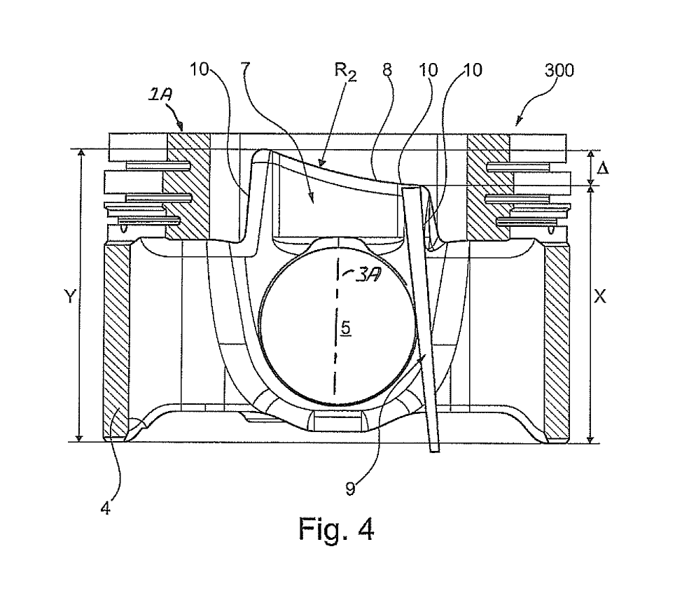

FIGS. 1A and 1B show a first exemplary embodiment of a piston 1 according to the invention having an inclined cooling chamber ceiling. FIGS. 2A and 2B show a second exemplary embodiment of a piston 100 according to the invention having an inclined cooling chamber ceiling. FIG. 3 shows a further exemplary embodiment of a piston 200 according to the invention having a concavely inclined cooling chamber ceiling. FIG. 4 in turn shows a further exemplary embodiment of a piston 300 according to the invention having a convexly inclined cooling chamber ceiling.

Identical elements are given identical designations in all the figures.

In the following description of the figures, terms such as top, bottom, left, right, front, rear, etc. relate exclusively to the exemplary illustration and position of the apparatus and other elements selected in the respective figures. Said terms are not to be understood to be restrictive, that is to say these references can change as a result of different positions and/or mirror-symmetrical design or the like.

FIGS. 1A, 1B, 2A, 2B, 3 and 4 show different exemplary embodiments of the piston 1, 100, 200, 300. In the following text, the common features of said pistons 1, 100, 200, 300 will be described. The pistons 1, 100, 200, 300 have a piston head 1A having a combustion chamber recess 2. A ring zone 3 is radially arranged on the outer circumference of the piston relative to a piston stroke axis 3A. A skirt 4 adjoins the ring zone 3. Pin boss bores 5 are arranged in the skirt 4. The interior space of the piston is delimited by way of the recessed walls (also called connecting walls) of the skirt 4 and by way of the surface which lies opposite the crown of the combustion chamber recess. An inner shape 6 lies opposite the crown of the combustion chamber recess 2, and a wall forms the boundary between said regions.

A cooling chamber 8 is configured circumferentially on the outer inner circumference of the piston. Said cooling chamber 8 is delimited by oil guiding surfaces 10. The oil guiding surface 10 which faces away from the pin boss bores 5 is formed by a cooling chamber ceiling 8. Said cooling chamber ceiling 8 is configured with a variable height over the circumference. The slope which is produced as a result is shown in section by way of points X, Y in the figures, X representing the height of the cooling chamber at the lowest point and Y representing the height of the cooling chamber at the highest point. This results in:

A=Y−X

X<Y

Δ (delta) therefore represents the height difference between Y and X. Furthermore, the value for X is smaller than the value for Y. The slope which is produced as a result is, for example, between 0.5° and 45°. Viewed three-dimensionally, these are surfaces.

The oil guiding surfaces 10 are wetted by an oil spray stream 9.

FIGS. 1A and 1B show said oil spray stream 9 in an inclined manner.

FIGS. 2A and 2B show a piston 100 having a cooling chamber 7 with a variable height over the circumference. Furthermore, alternative positions of the cooling chambers 7 or additional cooling chambers 7 are shown.

FIG. 3 shows a piston 200 having a concavely curved cooling chamber ceiling 8. This concave curvature guides the oil spray stream 9 away from its impact location. A radius R₁ represents the concave curvature of at least one oil guiding surface 10.

FIG. 4 in turn shows a piston 300 having a convexly curved cooling chamber ceiling 8. The convex curvature of the cooling chamber ceiling 8 also leads to improved discharging of the cooling oil away from the impact location of the oil spray stream 9. A radius R₂ describes the convex curvature of at least one oil guiding surface 10.

The above-described piston which is also claimed in the patent claims (either in general or according to the first or second exemplary embodiment) is used in a manner known per se in an internal combustion engine. The internal combustion engine has at least one cylinder chamber, in which the piston is arranged and can move up and down (oscillate) in a known way. The at least one oil spray nozzle (also called cooling oil nozzle) is present in a crankcase of the internal combustion engine, via which oil spray nozzle an oil jet exits in the direction of the piston crown, that is to say in the direction of the cooling chamber which is open toward the bottom, in order to feed the cooling medium to the cooling chamber which is open toward the bottom, which cooling medium sweeps along and therefore over the wall of the cooling chamber which is open toward the bottom, absorbs heat there and is subsequently guided back into the inner region of the piston and therefore also into the inner region of the crankcase, in order to dissipate the heat which is produced on account of the combustion in the region of the piston crown. Afterward, the cooling medium which is guided back into the crankcase is returned into the cooling circuit and can again be output as an oil jet through the spray nozzle.

### LIST OF DESIGNATIONS

1 Piston
1A Piston Head
100 Piston
200 Piston
300 Piston
2 Combustion chamber recess
3 Ring zone
3A Piston stroke axis
4 Skirt
5 Pin boss bore
6 Inner shape
7 Cooling chamber
8 Cooling chamber ceiling
9 Oil spray stream
10 Oil guiding surface
X Height of the cooling chamber at the lowest point
Y Height of the cooling chamber at the highest point
Δ (delta) Difference between Y and X
R₁ Radius, concave
R₂ Radius, convex

1. A piston for use in an internal combustion engine comprising:
a piston head having a horizontal wall including a cooling chamber ceiling surface;
a longitudinal piston stroke axis extending through a center of the piston head;
a piston skirt connected to the piston head and extending circumferentially about the piston stroke axis, the piston skirt having a pair of diametrically opposing walls recessed radially inward toward the piston stroke axis, the recessed opposing walls each having a pin boss defining a pin boss bore and an interior surface radially positioned from the piston stroke axis;
an open cooling chamber defined by the piston head cooling chamber ceiling surface and the recessed opposing walls interior surfaces, the cooling chamber is open from a bottom of the piston skirt below the pin boss bores and between the recessed opposing wall interior surfaces along the piston stroke axis, the cooling chamber ceiling surface extends across the piston stroke axis and includes an inclined slope, the cooling chamber ceiling surface and the recessed opposing wall interior surfaces respectively operable as three oil guiding surfaces for the transfer of heat away from the piston head.

2. The piston of claim 1, wherein the inclined slope of the cooling chamber ceiling is configured between a first point (Y) defining a vertically highest point of the cooling chamber ceiling and at least one further point (X) defining a vertically lowest point of the cooling chamber ceiling in the cooling chamber.

3. The piston of claim 1, wherein the cooling chamber has a direct connection to an inner shape.

4. The piston of claim 1, wherein the cooling chamber ceiling surface inclined slope further comprises a convex curvature in a direction toward the pin bosses.

5. The piston of claim 1, wherein the cooling chamber ceiling surface inclined slope further comprises a concave curvature in a direction toward the pin bosses.

6. (canceled)

7. The piston of claim 1 wherein the cooling chamber ceiling surface inclined slope is between 0.5 degrees and 45 degrees from horizontal.

8. The piston of claim 7 wherein the cooling chamber ceiling surface inclined slope is between 0.5 degrees and 5 degrees from horizontal.

9. The piston of claim 7 wherein the cooling chamber ceiling surface extends a full length between the recessed opposing walls interior surfaces.

10. The piston of claim 9 wherein the cooling chamber ceiling surface is substantially planar.

11. The piston of claim 1 wherein the cooling chamber ceiling surface extends a full length between the recessed opposing walls interior surfaces.

12. The piston of claim 11 wherein the cooling chamber ceiling surface is substantially planar.

13. The piston of claim 1 wherein the piston head further defines a combustion chamber recess positioned opposite the cooling chamber separated by the horizontal wall.

14. A method for cooling a piston of claim 1, comprising the steps:
directing of an oil spray stream onto the cooling chamber ceiling surface having the inclined slope;
wetting of the cooling chamber inclined ceiling surface with cooling oil;
guiding of the cooling oil along the cooling chamber inclined ceiling surface;
heat exchange between the cooling chamber inclined ceiling surface and the cooling oil; and
discharging of the heated cooling oil through the cooling chamber which is freely open from the bottom of the piston skirt along the piston stroke axis toward the pin boss bores.

15. A piston for use in an internal combustion engine comprising:
a piston head having a horizontal wall including a cooling chamber ceiling surface, the cooling chamber ceiling surface having an inclined slope at an angle including and between 0.5 degrees and 45 degrees from horizontal;
a longitudinal piston stroke axis extending through a center of the piston head;
a piston skirt connected to the piston head and extending circumferentially about the piston stroke axis, the piston skirt having a pair of diametrically opposing walls recessed radially inward toward the piston stroke axis and extending from the piston head parallel to the piston stroke axis, the recessed opposing walls each having a pin boss defining a pin boss bore and an interior surface radially positioned from and facing the piston stroke axis, the recessed opposing walls further having lower ends positioned below the pin bosses; and
an open cooling chamber defined by the inclined piston head cooling chamber ceiling surface and the recessed opposing walls interior surfaces, the cooling chamber is open from a bottom of the piston skirt between the recessed opposing walls interior surfaces and radially positioned about the piston stroke axis, the cooling chamber ceiling surface continually extends across the piston stroke axis between the recessed opposing walls interior surfaces, the cooling chamber is freely open laterally to and between the recessed opposing walls and the recessed opposing wall lower ends, wherein the cooling chamber ceiling surface and the recessed opposing wall interior surfaces respectively operable as three cooling oil guiding surfaces for the transfer of heat away from the piston head.
